(19) United States
(12) Patent Application Publication
(10) Pub. No.: US 2024/0407386 A1
(43) Pub. Date: Dec. 12, 2024

(54) System for roasting and brewing with in metal pod a single serving of coffee

(71) Applicant: Glen Poss, Nine Mile Falls, WA (US)

(72) Inventor: Glen Poss, Nine Mile Falls, WA (US)

(21) Appl. No.: 17/978,850

(22) Filed: Nov. 1, 2022

Related U.S. Application Data
(60) Provisional application No. 63/275,185, filed on Nov. 3, 2021.

(51) Int. Cl. A23F 5/04

(52) U.S. Cl. CPC A23F 5/04

(57) ABSTRACT

A gas tight pod used to both roast and brew a potable beverage with in the same pod. The pod is loaded with UN-roasted coffee in particularized form. The pod is then rotated in any orientation with in an induction field causing the “pod” to heat. The contents are heated via conduction.

The rotation of the pod can be started and stopped to allow for more even roasting. As the pod is sealed so no gasses created during roasting can escape into the atmosphere.

The pod now is immediately injected with a potable fluid of any temperature thus cooling the roasted coffee. The fluid mixes with the roasted coffee forming a beverage and the pod is allowed to drain into a serving cup.

Pod now full of wet roasted coffee can be disposed of and the decomposition of the pod hastened by the contents.

For the past 2 decades the rise of single serve pod machines for home and office has become a huge player in the global coffee market. These systems have traded on the concept of “fresh is only if fresh brewed” and the “convenience culture”. This convenience aspect extends from the storing, use and even clean up of the pod based systems. These systems also allow for a level of each serving being personalized. Each person can choose what they want and when plus they never have had to touch wet coffee grounds.

This market is dominated by 2 systems, Nespresso and Keurig, with between the two command over ⅓rd of the 30 million new brewer coffee market in the USA alone. It has been estimated that Nespresso sells 400 Nespresso pods every second. This is by any measure a very profitable business. Each Nespresso pod contains 6 grams of roasted and ground coffee, with a per unit price of $0.80 retail. This means that Nestle' is charging in effect just over $60.00 a lb for the coffee. The average for whole bean coffee retail averages $8 to $15 a lb. The Keurig system is comparable in margin's but slightly lower as they average 10 grams per pod.

The single serve pod market has changed over time largely it grew in popularity but also the patent protection that both companies relied on to protect their markets ended. This still growing market now meant that both Nespresso and Keurig have to compete against the own older products, supplied and retailed by companies at a much lower price but still offering the core advantage. Both companies attempted to blunt this competition and retain their market by introduction new machines and new pods that only worked with in the new machines.

The Nespresso Vertuo machine is Nespresso response to the market reality. It not only uses special “smart” pod. This smart pod has a bar code around the ring it's initial use Is to tell the machine that it has an approved pod but down the road it will likely that with the inclusion of WiFi with in the brewer an ability to track the consumption of pods by that machine and a connection to a “pantry” function. The Nespresso Vertuo uses a new and “better” brewing method using centrifugal extraction further making the case that the new system is in fact better and supports the higher price. Nespresso is marketing the new system aggressively.

Keurig went down a slightly different path. The Keurig 2.0 v1 machine reads each lid to identify 2.0-compatible brands with the promise of “better flavor”. This was an attempt to lock out all 3″ party suppliers, ones that are not paying Keurig the per pod royalty. However, these machines were swiftly discontinued in 2019 after incredible consumer backlash. The Keurig 2.0 v2 is their newest breed of coffee maker, one that in theory accepts all pods “at this time”. These new coffee machines new abilities, like the K Carafe for making a larger brew, unique K-Cup pods, carafe pods.

The Keurig 2.0 first banned the usage of any third-party K-Cup, but that is no longer the case the new ones let you use the same pods that are now available for 1.0 and 2.0, and the brew strength is arguably superior or so it is claimed. It is expected that among the “new features” that will be part of the new brewers will be IoT and be linked to many shopping platforms.

### Changing Definition of What High Quality Coffee Is

The coffee cafe industry has seen other major shifts, some due to the pandemic others not. During 2020 there was a huge shift away from “sit down” cafe's and to diver through/walk up coffee drink retailers. This shift was so great that Starbucks closed many of their cafe's and reduced on drive t through locations. This was not the only shift that the pandemic caused that included a strong growth in at home coffee systems that provided a much higher level of quality than before. This was not the only shift in the coffee cafe business, one other major one was announced and by a massive player but because of the pandemic it was put on the back burner for a year. Changing the goal post, what is fresh in coffee. This was the announcement of the Roastilier program by Nestle' on Jan. 14, 2020. This program was a major and fundamental shift in the coffee in dusty. Nestle' had up until that time been a support player in the coffee cafe' business but with this program they announced that they were going to be a big player in coffee cafe' business world wide and they picked a system that would give them a fundamental advantage over all their competitors. The Nestle' Roastilier program lets every cafe, ever drive through and every walk up the ability with out training to offer each customer custom fresh roasted coffee. Their bench mark for “fresh” is not 3 weeks old, or 3 days old but 3 hours after roasting. This has been the benchmark time post roast traditionally in the coffee industry where the Ethiopians continue to this day to “roast, grind and brew while still warm from roasting”. The industry abandoned this time line over a century ago, the focus was on massive quantities at low cost. Even though the trend had been happening slowly with in the cafe business to “roast in cafe” with even Starbucks following that plan it was happening slowly. This was due in large part as to the cost and complexity of roasters with in the cafe and the required training of a key employee but as competition became more significant and the customers became more sophisticated it was happening. Coffee has always been sold on the basis of “fresh” for a century it was “fresh brewed” with hand waving as to when and how it was roasted either ignored or by creation of a myth that roasted coffee had to “rest”. This was largely done for a couple of reasons, chief among them was the whole industry and it's business model was predicated on the process of roast, package, sell. This massive industry had created a system that made it almost impossible to attack, it was just too big, that was until a massive company decided that they could dominate the whole of the coffee cafe industry by changing the metric of quality to one that the others could not match, that was custom fresh roast in each and every cafe, drive through, walk up. They would change what was considered quality and fresh. It would take massive effort, but Nestle' had done it before to great profits, after all the Nespresso system lets them selling 15 lbs of $60.00 a lb coffee every second, 24/7.

Nestle' a huge company with massive marketing abilities offer to each and every non chain coffee drink retailer something new, something different, something that every customer can understand while their chain competition has to try to explain away the difference, to go against Nestle's marking muscle. Yes the cafe's are tied into the Nestle' eco system, they are using their packets, their roasters, and even relighting on their marketing but it hardly matters it's always been very hard to sell “stale, old” coffee. So Nestle' is going to change the definition of what fresh is in coffee, and toss into the mix each customer can decided on what is perfect for them. They will offer tailored not off the rack. This all sounds great, and it is. This will fundamentally change the coffee business and except that a monster the size of Nestle' would be almost impossible to do.

So Nestle' is going to shake up the out of home coffee business, they will largely own the new definition of quality in that market but what of the home market? Owning that new definition it would be a game changer if Nestle' could bring that into the home too. In the past it was assumed that it was impossible to offer a single serve disposable pod system that would custom roast and brew coffee on demand, quickly in the home. A system that required no training, no skill, a plug and play unit. This would resurrect the in home coffee beverage market and provide Nestle' provide an easily marketed group of advantages and decades of patent protection.

In the process of creating the ARIA, the goal was to create a simple inexpensive, smoke, odor free coffee roasting system for the home. This required a clean sheet of paper design, something that had never been done before. Even though the roaster tech and the process end to end was aimed at the home user we came to understand that the system was scale-able. Our simple bench top system could with out losing any of it's advantages be a direct competitor to the Roastilier system in the cafe. In the process of developing the ARIA a number of tests were made some to vary the size of the load of the roaster load, some in an attempt at reducing roasting time. In the process of doing this base experimentation a few things were discovered, one of them lead to a system that would do what was considered by many impossible “a single serve disposable pod system that would custom roast and brew coffee on demand, quickly in the home.” This system utilizes a process that has a number of key features of the Nespresso Ventruo with it's disposable, and recyclable aluminum pod its simple operation, low cost and modest foot print. This means that Nestle' or another company could introduce the product into the market with few changes needed to the pod production line. The new roast and brew machine is in fact based upon the Nespresso Ventruo brewer but it easily could be a modification of any pod based coffee brewer system. Now, the new benchmark in quality coffee, custom fresh roast and brewed can be one button easy anywhere. Billions of dollars will be made for decades all it takes is bit of marketing muscle.

### BRIEF DESCRIPTION OF DRAWINGS

FIG. 1 cross section of pod assembly

FIG. 2 cross section of pod loaded into machine and machine components

FIG. 3 cross section of pod in machine with an exploded perspective view of pod, machine and components of machine

FIG. 4 cross section of pod in machine with an exploded perspective view of pod, machine and components of machine with pod at zero RPM

FIG. 5 cross section of pod in machine with an exploded perspective view of pod, machine and components of machine pod is now spun where particles (b) are spun at a sufficient RPM for centripetal force to effect the particles (b)

FIG. 6 Cross section view of pod, and machine with brew system dispenser (g, d, c, k) in its retracted position.

FIG. 7 Cross section view of pod, and machine with brew system dispenser (g, d, c, k) in its down and brewing position. The pod is spun to where particles (b) are spun at a sufficient RPM for centripetal force to effect the particles (b) the components compromising the brew system are allowed to spin around the axis as described by the location of the item (c)

FIG. 8 Cross section of pod in horizontal position with perspective view of pod.

FIG. 9 Cross section of pod in horizontal position with components of the machine. An exploded view of the machine, it's components and pod. A exploded perspective view is provided.

FIG. 10 Cross section of pod in horizontal position with components of the machine and the pod being rotated at sufficient RPM for the particles (b) to be under centripetal force.

FIG. 11 Cross section of pod in horizontal position with components of the machine and the pod not being rotated allowing particles (b) to fall to the bottom of the pod. An exploded perspective drawing of machine, pod and it's components are shown below.

FIG. 12 cross section of pod in machine with the machine not rotating pod (a) and with the inductor (I) not energized.

FIG. 13 Cross section view of pod, and machine with brew system dispenser (d, c, j) in its retracted. The pod is spun to where particles (b) are spun at a sufficient RPM for centripetal force to effect the particles (b)

FIG. 14 Cross section view of pod, the pod the pod is no longer being rotated and machine with brew system dispenser (d, c, j) has now pierced the lid of the pod (a) with brew fluid flowing into the pod (a) through the tube (c) spraying into the pod (a) then through now roasted particles (b) and out the tube (g) and then into the beverage container.

### DETAILED DRAWING DESCRIPTIONS

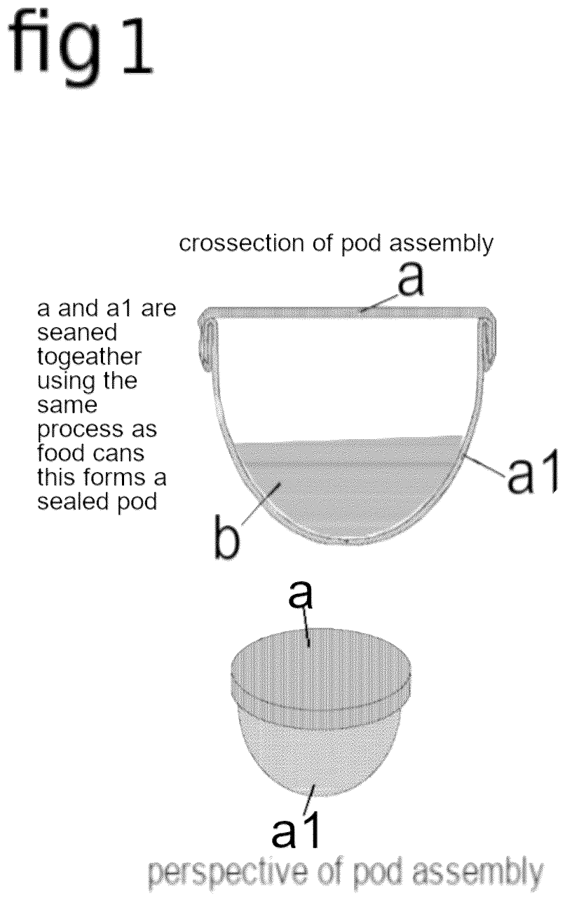

### FIG. 1

Shows a cross section of the pod assembly (a and a1) with the pod (a) in vertical position. The pod construction and materials are the same as used in the Nespresso Vertuo. Pod and contents can be during roasting process be in any orientation. The pod (a) is consists of a un-coated aluminum closure of variable size to accommodate different beverage sizes while still providing enough volume for the green coffee partials (b) to move and there by allowing mixing to take place during roasting. The pod (a) uses a crimped on or seamed on aluminum foil lid rather than the plastic one others use. The pod (a) lid and is attached by crimping or seaming and not by adhesive or ultrasonic welding.

The pod (a) is sized to produce the same cubic volume of brewed beverage so would produce the same beverage size as an espresso pod.

The ground green coffee (b) with in the pod (a) has been pulverized to 0.65 mm in diameter and the coffee load will be adjusted to suite the fluid to roasted coffee ground ratio to effect the desired beverage size.

This extra volume with in the pod (a) is to allow for the particularized green coffee (b) to expand while roasting takes place and to allow for mixing of the green coffee particles during the roasting process to facilitate a faster and more consistent end product.

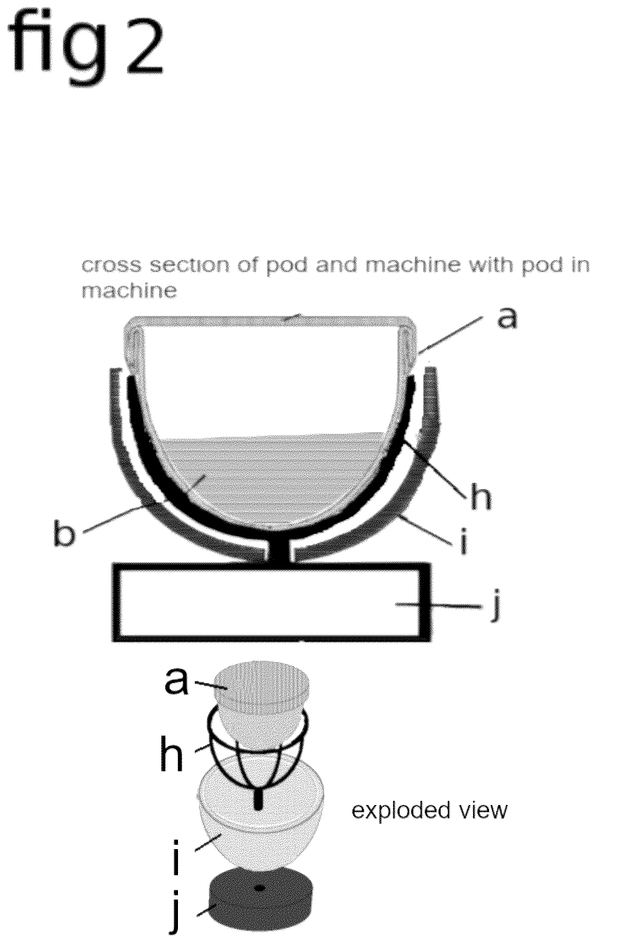

### FIG. 2

he pod (a) has been loaded into the appliance and the appliance may have been informed as to what type of pod (a) it is based on the data contained with in the bar code or the attached RFID tag. The memory in the CPU of the appliance now presents the options will be offered based on the user input and data contained on the pod (a).

The component parts of the roast and brew machine are as follows. (b) the ground ground green coffee is in the bottom of the pod as dictated by gravity (a) as the roast process and the brew process has yet to take place. The drive cup (h) is attached to the motor (j) is not rotating at this time it and the loaded pod (a) is now within the magnetic field generated by the coil (i) and there for the pod and it's contents (a and b) can be heated via conduction of the heat generated in the pod (a) via magnetic induction operating at a frequency of from 10 Khz to 1000 Khz as supplied by an electronic circuit that powers the coil under direction of the CPU.

The pod (1) has been loaded into the machine and the machine has noticed what type of pod it is based on the memory in the CPU what options will be offered. (1). The component parts of the roast and brew machine are as follows. (2) the ground ground green coffee is in the bottom of the pod (1) as the roast process and the brew process has yet to take place. The drive cup (8) attached to the motor (10) is not rotating, but is within the magnetic field generated by the coil (9) and there for the pod and it's contents (1 and 2) will be heated via conduction of the heat generated in the pod (1) via magnetic induction at from 10 Khz to 1000 Khz frequency.

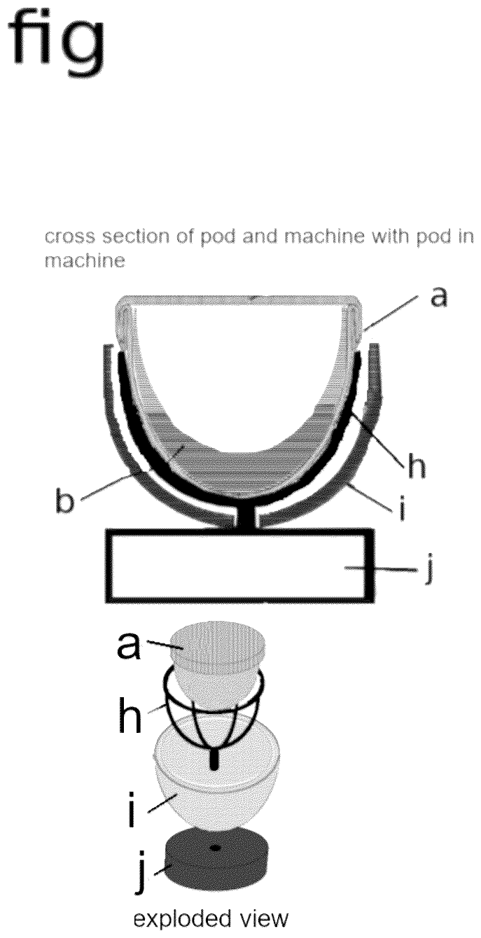

### FIG. 3

The green coffee partials (b) with in the pod (a) is spun by the pod via rotation of the drive cup (h) via the attached motor (j) at sufficient RPM for the particularized green coffee (b) to move up the walls of the pod (a) via centripetal force. The induction heating system coil (i) is heating the pod (a) and contents (b) via the alternating magnetic field provided by the electronic circuitry and the induction coil (I) The magnetic field penetrates the pod (a) and passes through the non conductive drive cup (h) The heating system comprising the coil and electronic circuit generating the alternating pulses generates electric currents inside the coil (i) called eddy currents. The eddy currents flow through the resistance of the material, and heat it by Joule heating. In ferromagnetic and ferromagnetic materials, such as iron, heat is also is generated by magnetic hysteresis losses though the drive cup (h) that is made of a non conductive material. This process heats the pod (a) and its contents (b) the particularized ground green coffee (b). Due to the effect of the spinning motion of drive cup (h) as imparted the motor system (j) resultant centripetal force action on the particularized green coffee (b) now moves the particularized green coffee (b) into the area in the upper corners of the pod (a) and is held there as long as the motor (j) and drive cup (h) continue to spin the pod (a) and it's contents (b) at a rate that impart the centripetal force on the contents (b) of the pod (a). When the rotation of drive cup (h) and the pod (a) and it's contents (b) stop the contents (b) are no longer under the effect of centripetal force that counter acts gravity, gravity now imparts a vertical moment of the contents (b) facilitate the mixing of the particles of the ground green coffee aka contents (b)

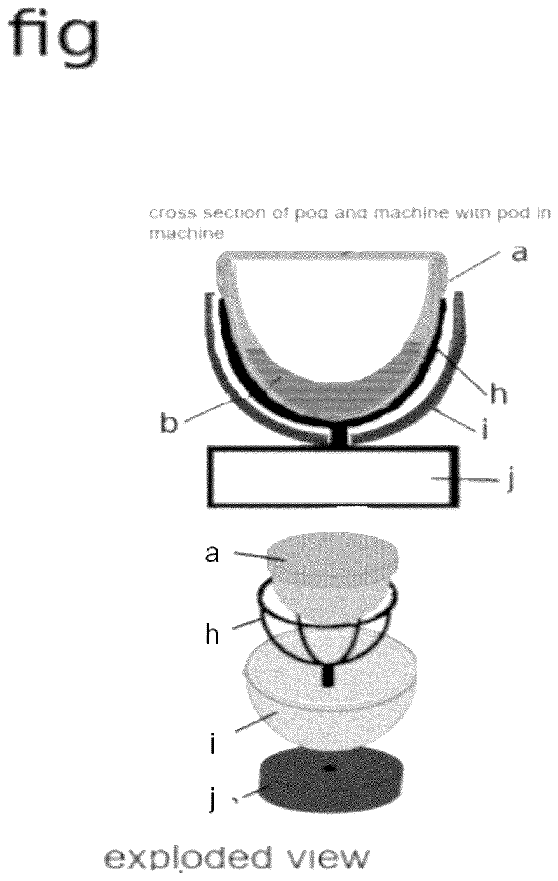

### FIG. 4

The pod (a) now NOT spun by the drive cup (h) via motor (j) at a RPM sufficient to impart centripetal effects on the contents of pod (b) The heating system comprised in part of the coil (i) can still be heating the pod (a) though the drive cup. The now stationary pod (a) and contents (b) with in the pod (a) are held in drive cup (h) It should be noted that the drive cup (h) is preferentially to be made of non ferrous non conductive material such as high temperament silicon rubber that can operate for long periods of time a the temperatures of 260 C and over. The heating of pod (a) and its contents (b) via the high requency current as supplied by the induction coil (i) continues and via conduction the contents (b) are heated. This can take place no matter the rate the pod (a) and its contents (b) that are held with in the drive cup (h) is spun at by the motor (j) attached to the drive cup (h). The process of the motor (j) spinning the drive cup (h) and pod (a) and it contents (b) and stopping the spin continues. This start and stop of the rotation of the drive cup allows for the mixing of the pod (1) contents (2) shortening the time that the roasting process requires and provides a more even result.

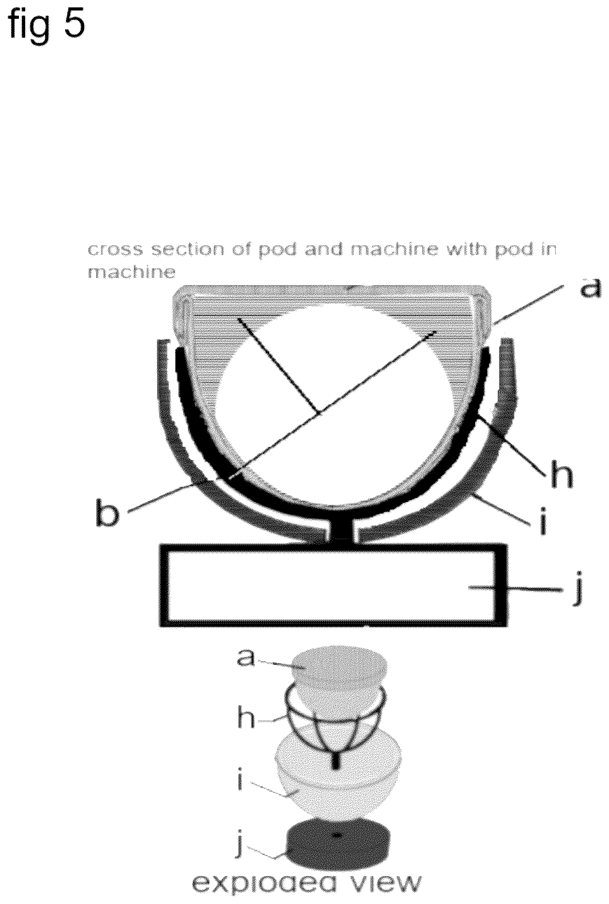

### FIG. 5

The green coffee partials (b) with in the pod (a) is spun by the drive cup (h) via the attached motor (j) at sufficient RPM for the particularized green coffee (b) to move up the walls of the pod (a) via centripetal force. The induction coil (i) is heating the pod (a) and it's contents (b) via the alternating magnetic field provided by the electronic circuitry and the induction coil (I) The magnetic field penetrates the pod (a) and passes through the non conductive drive cup (h) The heating system comprising the coil and electronic circuit generating the alternating pulses generates electric currents inside the coil (i) called eddy currents. The eddy currents flow through the resistance of the material, and heat it by Joule heating. In ferromagnetic and ferromagnetic materials, such as iron, heat is also is generated by magnetic hysteresis losses though the drive cup (h) that is made of a non conductive material. This process heats the pod (a) and its contents (b) The particularized ground green coffee (2) due to the effect of the spinning motion of drive cup (h) as imparted the motor system (j) resultant centripetal force action on the particularized green coffee (b) now moves the particularized green coffee (b) into the area in the upper corners of the pod (a) and is held there as long as the motor (j) and drive cup (h) continue to spin the pod (a) and it's contents (b) at a rate that impart the centripetal force on the contents (b) of the pod (a). When the rotation of drive cup (h) and the pod (a) and it's contents (b) stop the contents (b) are no longer under the effect of centripetal force that counter acts gravity and so gravity now imparts a vertical moment of the contents (b) facilitate the mixing of the particles of the ground green coffee contents (b)

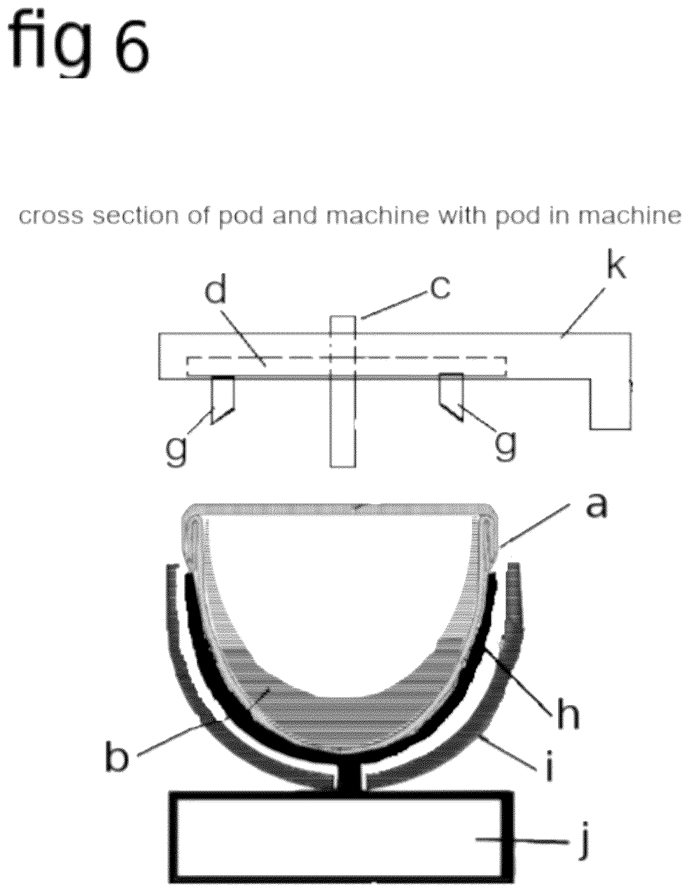

### FIG. 6

The roasting process now continues but the motor (j) attached to the drive cup (h) holding the pod (a) and its contents (b) spinning at a rate that is less than the RPM needed for centripetal forces to act on the contents of the pod (a). The induction coil (I) is still operating providing heating to the pod (a) and it's contents (b) allowing roasting to continue. Shown now is the brewing assembly in It's retracted position the brewing unit is comprised of components (d) (c) (k) and (g). The brew assembly is shown in position to allow roasting to take place while the pod (a) is still a sealed unit thus preventing any escape of smoke or odor into the environment. This position would also allow a pod (a) to be inserted into the drive cup (h) or removed from it.

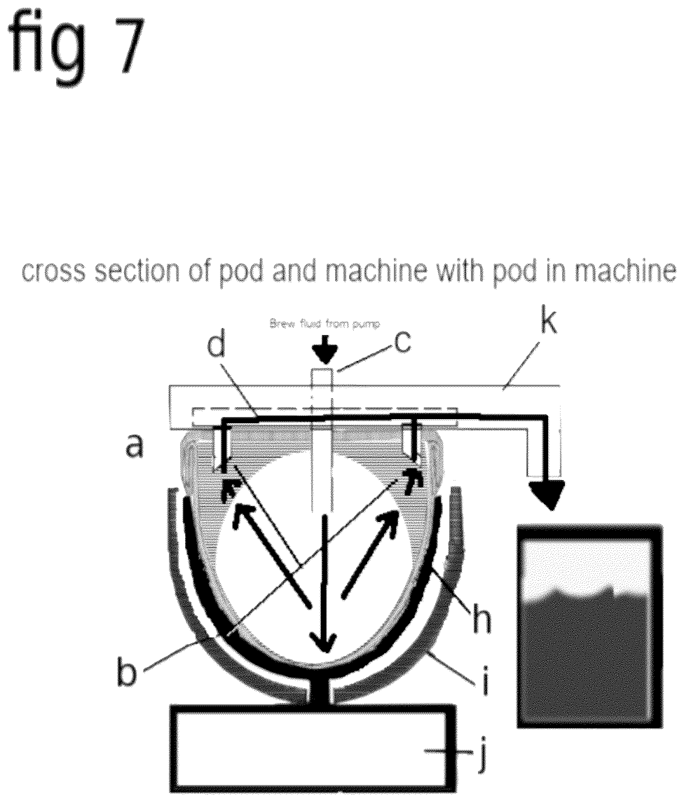

### FIG. 7

The brewing process now commences. The first action is that the pod (a) and it's contents (b) no longer rotate the drive cup (h) is no longer being spun by the attached motor (j) this allows the brew assembly comprising of components (k) the rotating seal the (g) brew fluid spouts that are attached to the rotating seal (k) that rotates around the fluid injector (c) allowing the pod to freely rotate with the pod (a). The components of the brew assembly (c) and (g's) now pierce the metal foil lid of the pod (a). This forces any gasses trapped with in the pod to now escape through the brew spigots (g) through the brew spout (o) The assembly is held in place with sufficient force to allow for a fluid tight seal to be effected between the pod (a) and the rotating disk (k) that is a component part of brew assembly. fluid is now injected into the pod causing the now roasted coffee to cool from It's roasting temperature of up to 500 F user defined temperature not to exceed 200 F. Prior to the point that the fluid injector (c) and the brew spigots (g) pierce the pod (a) lid the pod (a) had been sealed preventing the escape of any roasting gasses into the environment. The pod now starts to spin at RPM that are sufficient for the roasted coffee grounds to be acted on by centripetal force and moving to the upper corners of the pod (a) the hot fluid from the heater being pumped into the pod (a) through the fluid inlet (c) as the drive cup (h) is spun by motor (j) under the direction of the CPU contained with in the appliance.

The now roasted ground coffee (b) due to the effect of the motion of drive cup (h) via motor (j) that Is rotating the assembly at a RPM sufficient for the and the centripetal force to Impart on the ground and now roasted coffee (b) to now move into the area in the upper corners of the pod (a). The brew fluid that is injected into the pod (a) now also is subject to the centripetal and now flow's through the roasted coffee causing fluid to interact with the soluble components of the roasted coffee particles contained with in the pod (a) extracting flavor components. The solution now moves through the coffee grounds and then through the brew spirits (g) and then out through the brew spout (o) and into the beverage container.

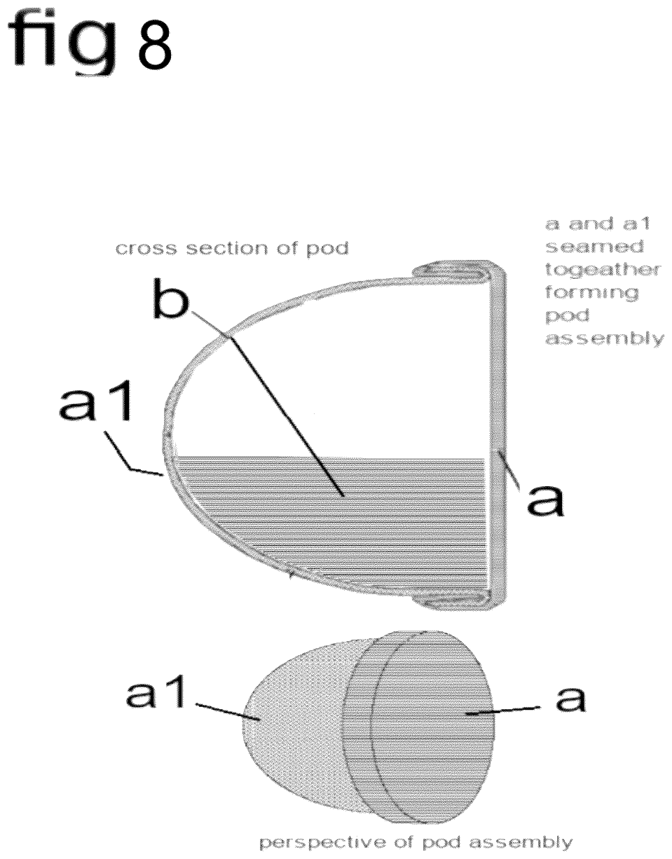

### FIG. 8

Shows a cross section of the pod (a) with the pod (a) in horizontal position. The pod construction and materials are the same as used in the Nespresso Vertuo. Pod and contents can be during roasting process be in any orientation. The pod (a) is consists of a uncoated aluminum closure of variable size to accommodate different beverage sizes while still providing enough volume for the green coffee partials (b) to move and there by allowing mixing to take place during roasting. The pod (a) uses a crimped on or seamed on aluminum foil lid rather than the plastic one others use. The pod (a) lid and is attached by crimping or seaming and not by adhesive or ultrasonic welding. The pod (a) is sized to produce the same cubic volume of brewed beverage so a “mug” size would produce the same beverage size as an espresso pod.

The green coffee (b) contained with in the pod (a) has been pulverized to 0.65 mm in diameter and the coffee load will be adjusted to suite the fluid to roasted coffee ground ratio to effect the desired beverage size. This extra volume with in the pod (a) is to allow for the particularized green coffee (b) to expand while roasting takes place and to allow for mixing of the green coffee particles during the roasting process to facilitate a faster and more consistent end product.

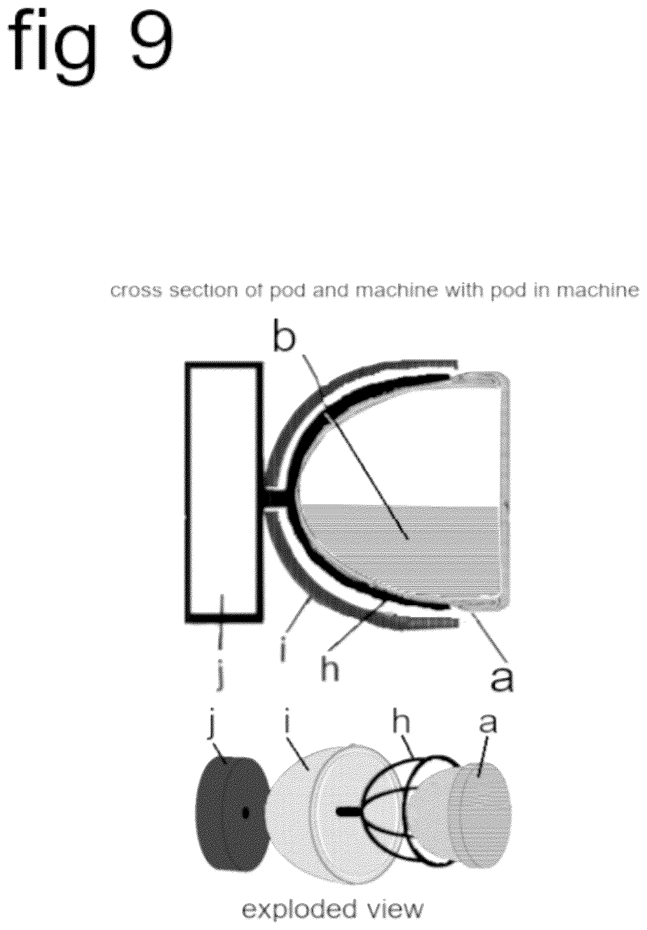

### FIG. 9

The pod (a) has been loaded into the appliance. This appliance and the pod (a) have a horizontal orientation like a Nespresso pixie. The appliance may have been informed as to what type of pod (a) it is based on the data contained with in the bar code or the attached RFID tag and thus able to modify the roasting and brewing process to suit the customers desire. The programming in the CPU of the appliance now presents the options will be offered based on the user input and data contained on the pod (a). The component parts of the roast and brew machine are as follows. (b) the ground ground green coffee is in the bottom of the pod (a) as dictated by gravity. The drive cup (h) is attached to the motor (j) the loaded pod (a) however is within the magnetic field generated by the coil (i) the pod and it's contents (a and b) can be heated via conduction of the heat generated in the pod (a) via magnetic induction. The system is operating at a frequency of from 10 Khz to 1000 Khz as supplied by an electronic circuit that powers the coil under direction of the CPU.

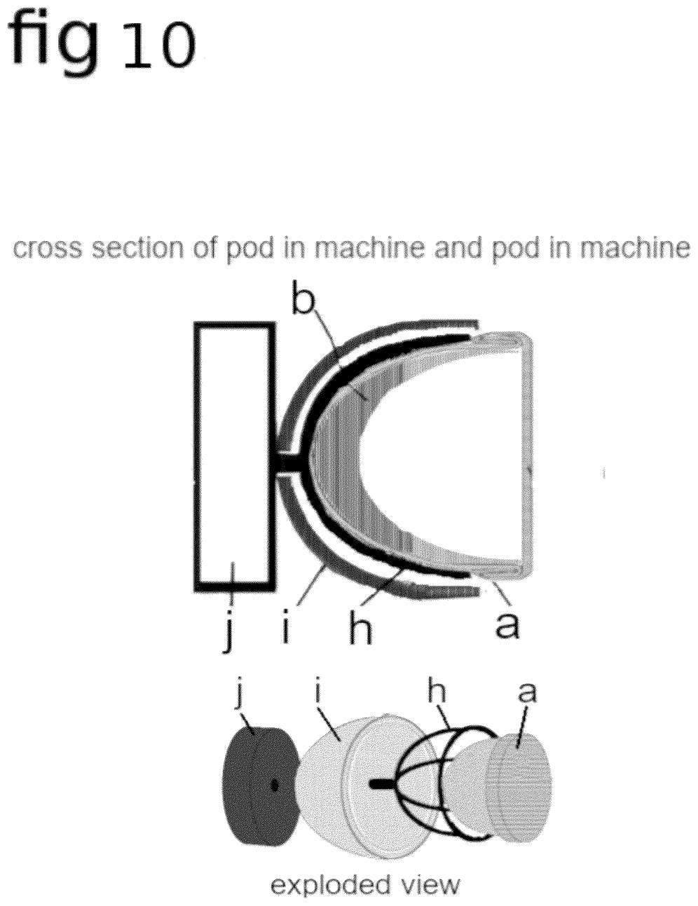

### FIG. 10

The green coffee partials (b) with in the pod (a) is spun by the pod via rotation of the drive cup (h) via the attached motor (j) at sufficient RPM for the particularized green coffee (b) to be affixed to the walls of the pod (a) via centripetal force. The induction heating system coil (i) is heating the pod (a) and it's contents (b) via the alternating magnetic field provided by the electronic circuitry and the induction coil (I) The magnetic field penetrates the pod (a) and passes through the non conductive drive cup (h) The heating system comprising the coil and electronic circuit generating the alternating pulses generates electric currents inside the coil (i) called eddy currents. The eddy currents flow through the resistance of the material, and heat it by Joule heating. In ferromagnetic and ferromagnetic materials, such as iron, heat is also is generated by magnetic hysteresis losses though the drive cup (h) that is made of a non conductive material. This process heats the pod (a) and its contents (b) The particularized ground green coffee (b) due to the effect of the spinning motion of drive cup (h) as imparted the motor system (j) resultant centripetal force action on the particularized green coffee (b) now moves the particularized green coffee (b) into the area in the upper corners of the pod (a) and is held there as long as the motor (j) and drive cup (h) continue to spin the pod (a) and it's contents (b) at a rate that impart the centripetal force on the contents (b) of the pod (a). When the rotation of drive cup (h) and the pod (a) and it's contents (b) stop the contents (b) are no longer under the effect of centripetal force that counter acts gravity, gravity now imparts a vertical moment of the contents (b) facilitate the mixing of the particles of the ground green coffee contents (b) The RPM of the drive cup (h) the pod (a) the contents of the pod (b) do not have to be in the RPM rage to provide centripetal effect to the content's of the pod (a) and can be much lower allowing for a continuous rotation of the pod (a) much like the motion of a clothes dryer allowing the design of the appliance to be simpler and the operation of the system quieter.

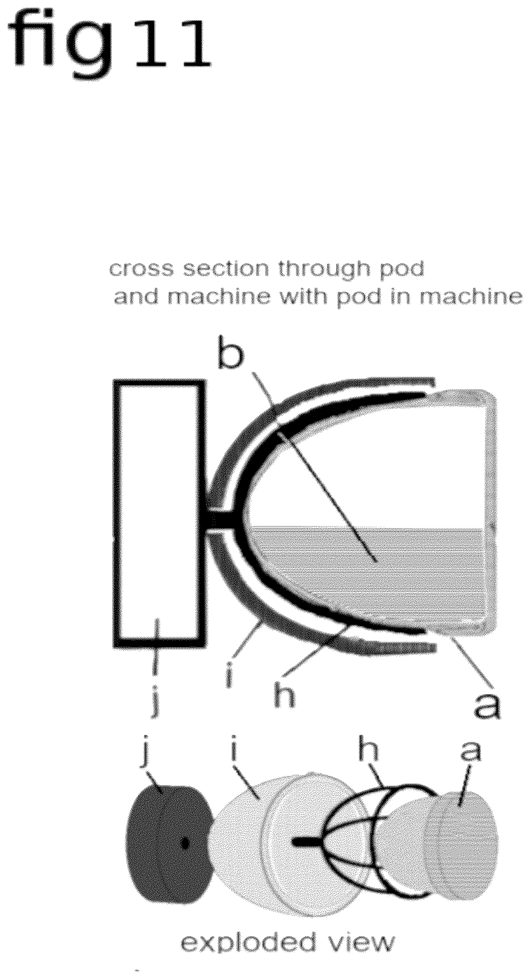

### FIG. 11

The pod (a) now NOT spun by the drive cup (h) via motor (j) at a RPM sufficient to impart centripetal effects on the contents of pod (b) The heating system comprised in part of the coil (i) can still be heating the pod (a) though the drive cup. The now stationary pod (a) and contents (b) with in the pod (a) are held in drive cup (h) It should be noted that the drive cup (h) is preferentially to be made of non ferrous non conductive material such as high temperament silicon rubber that can operate for long periods of time a the temperatures of 260 C and over. The heating of pod (a) and its contents (b) via the high frequency current as supplied by the induction coil (i) continues and via conduction the contents (b) are heated. This can take place no matter the rate the pod (a) and its contents (b) that are held with in the drive cup (h) is spun at by the motor (j) attached to the drive cup (h). The process of the motor (j) spinning the drive cup (h) and pod (a) and it contents (b) and stopping the spin continues. This start and stop of the rotation of the drive cup allows for the mixing of the pod (1) contents (2) shortening the time that the roasting process requires and provides a more even result.

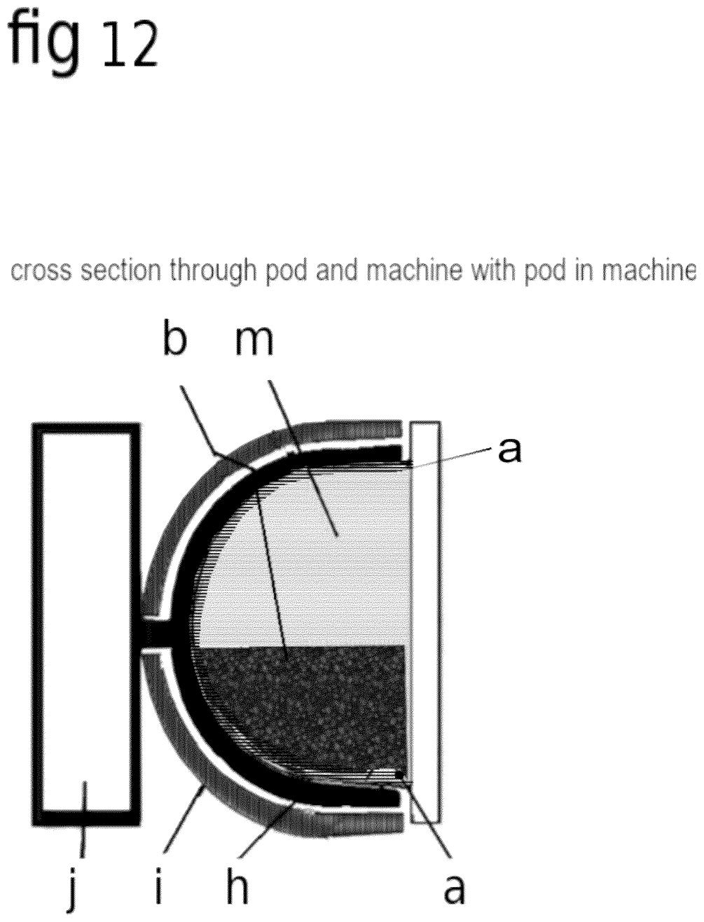

### FIG. 12

The roasting process now continues but the motor (j) attached to the drive cup (h) holding the pod (a) and its contents (b) spinning at a rate that is less than the RPM needed for centripetal forces to act on the contents of the pod (a). The Induction coil (I) is still operating providing heating to the pod (a) and it's contents (b) allowing roasting to continue. Note all roasting is taking place while the pod (a) is still a sealed unit thus preventing any escape of smoke or odor into the environment.

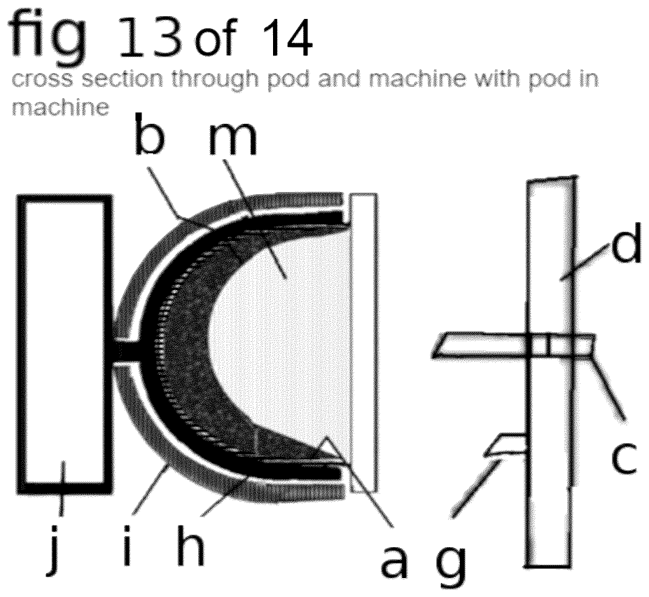

### FIG. 13

The roasting process now complete based on the information on that pod, it's contents, prior curation and the users desires. The motor (j) attached to the drive cup (h) holding the pod (a) and its contents (b) have stopped spinning The induction coil (I) is not operating and not providing heating to the pod (a) and it's contents (b) but roasting continues and will so until the roasted coffee is cooled via air or fluid to below 250 F. Shown now is the brewing assembly in It's retracted position. The brewing unit is comprised of components (d) the brewed beverage spout (c) the brew fluid injector (g) the brewed beverage spigot. The brew assembly is shown in its' retracted position. This position allows for the completed pod (a) with it's contents (b) to be inserted into or removed from the drive cup (h) prior or after roasting and or brewing.

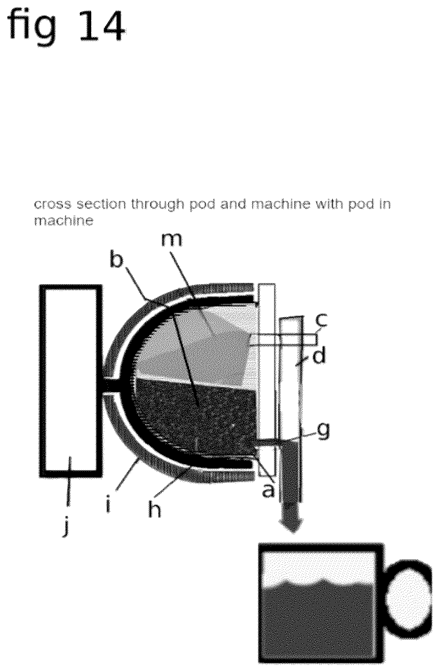

### FIG. 14

The brewing process now commences. The first action is that the pod (a) and it's contents (b) no longer rotate this allows the brew assembly comprising of its components (g) the brew fluid spigot, the fluid injector (c) and the brewed beverage spigot (d) to move into a position where the components of the brew assembly (c) and (g) now pierce the metal foil lid of the pod (a) The pod (a) lid is attached by seaming or crimping. This prevents any gasses from escaping into the environment until such time as the brew assembly components (c and g) pierce the foil lid. Gasses trapped with in the pod as a by product of roasting are cooled by the fluid injection to below the roasting temperature of up to 500 F. The gases now escape through the brew spigot (g) and through the brew spout (d). The brew process continues with he hot fluid from the heater being pumped into the pod (a) through the fluid inlet (c) under the direction of the CPU contained with in the appliance the rate and volume of brew fluid that can be user defined via a menu on the appliance or part of the curation. The brew fluid (m) that is injected into the pod (a) flow's through the roasted coffee causing the fluid to interact with the soluble components of the now roasted or partly roasted coffee particles contained with in the pod (a) extracting flavor components. The solution now moves through the coffee grounds and then through the brew spigots (g) and then out through the brew spout (d) and into the beverage container.

1: A sealed metal pod containing a measured amount of whole or particles of green coffee where within the pod the conversion from a green to a heated state “roasted” takes place via the pod being heated by an external method and when “roasting” is done fluid is injected into the pod there by forming a solution that may be consumed. a.
A: sealed closed pod where the pod is made of metal preferably mild steel and or aluminum that is from point 0006 inch thick to point 25 inch thick.
B:. A closed pod where one end closure is of thin metal preferably mild steel and or aluminum that is between point 0006 inch to point 10 inch thick. c. A closed pod that contains from point 5 grams to 700000 grams of green un-roasted coffee.

2: A closed pod that contains a measured amount of green un-roasted coffee that has been ground or formed into particles from the size of point 6 mm to 2 mm.
A. A closed pod that is rotated in any orientation by a motor or other means but only during the process of converting the material contained with in from a green raw state to another state via heating of the metal pod and it's contents.
B. A closed pod that rotated in any orientation by a motor or other means at a rate of 0 to 10000 RPM and may be stopped and started during the of converting the material contained with in from a green raw state to another state via heating.
C. The pod can be rotated to a sufficient rate so that the contents experience centripetal forces, this rotation can be started and or stopped to allow for the contents to experience gravity and thus allowing for the particles to mix becoming more uniform in conversion by heating from green raw state to another state.

3: A form or shape that mimics the shape of the pod and is attached to a motor or other means to allow for the rotation of it and the pod during the process of conversion of the green coffee into another state bu the application of heat a.
A. A form or shape that mimics the shape of the pod but is constructed of material that is designed to operate at temperatures that the pod will undergo during the process of conversion of the green coffee into another state through the application of heat
B. A central processing unit that controls the rotation of the pod, the application of heat to the pod and the injection of the fluid into the pod.
